(19) United States
(12) Patent Application Publication
(10) Pub. No.: US 2015/0010183 A1
(43) Pub. Date: Jan. 8, 2015

(54) Methods, Systems, and Devices for Selecting Spectral Components

(71) Applicants: Bastiaan van Dijk, Antwerp (BE); Brett Swanson, Meadowbank (AU)

(72) Inventors: Bastiaan van Dijk, Antwerp (BE); Brett Swanson, Meadowbank (AU)

(21) Appl. No.: 14/324,045

(22) Filed: Jul. 3, 2014

Related U.S. Application Data
(60) Provisional application No. 61/842,934, filed on Jul. 3, 2013.

(51) Int. Cl. H04R 25/00

(52) U.S. Cl. CPC H04R 25/30; H04R 2225/67
USPC 381/320

(57) ABSTRACT

Methods, systems, and devices for selecting one or more spectral components to include in a stimulation signal are disclosed. An example sound processor is configured to generate a stimulation signal based on one or more spectral components having an energy that is greater than or equal to one or more threshold energies. Each of the one or more spectral components represents an energy of a sample of an audio signal at one of M frequency channels, where M is a positive integer.

### CROSS-REFERENCE TO RELATED APPLICATION

Priority is claimed to U.S. Provisional Patent Application No. 61/842,934, filed on Jul. 3, 2013, the contents of which are hereby incorporated by reference.

### BACKGROUND

Individuals who suffer from certain types of hearing loss may benefit from the use of a hearing prosthesis. Depending on the type and the severity of the hearing loss, an individual can employ a hearing prosthesis to assist in perceiving at least a portion of a sound. A partially implantable hearing prosthesis typically includes an external component and an internal (implanted) component. The external component performs at least some processing functions. The implanted component delivers a stimulus to a body part in an auditory pathway, such as a cochlea, an auditory nerve, a region of a brain, or any other body part that contributes to the perception of sound. In the case of a totally implantable hearing prosthesis, the entire device is implanted in the body of the recipient.

### SUMMARY

A sound processor is disclosed. The sound processor is configured to generate a stimulation signal based on one or more spectral components having an energy that is greater than or equal to one or more threshold energies. Each of the one or more spectral components represents an energy of a sample of an audio signal at one of M frequency channels, where M is a positive integer.

A non-transitory computer-readable memory is disclosed. The non-transitory computer-readable memory has stored therein instructions executable by a computing device to cause the computing device to perform functions. The functions include generating a spectral signal that includes M spectral components of an audio signal. Each spectral component includes information indicative of an energy of the audio signal in one of M frequency channels, with M being a positive integer. The functions also include determining, for each of the M spectral components, whether the energy of the spectral component is less than a threshold energy of a corresponding frequency channel. In response to determining that the energy of the spectral components is less than the threshold energy, the functions include removing the spectral component from the spectral signal. The functions additionally include generating a stimulation signal based on one or more of the M spectral components remaining in the spectral signal.

A method is also disclosed. The method includes determining an average of a number of spectral components used to generate one or more stimulation signals during an interval. The method also includes making a determination that the average and a target number are different numbers. In response to making the determination, the method includes adjusting a threshold energy used to select one or more subsequent spectral components, with the one or more subsequent spectral components being used to generate one or more subsequent stimulation signals.

These as well as other aspects and advantages will become apparent to those of ordinary skill in the art by reading the following detailed description, with reference where appropriate to the accompanying drawings. Further, it is understood that this summary is merely an example and is not intended to limit the scope of the invention as claimed.

### BRIEF DESCRIPTION OF THE FIGURES

Presently preferred embodiments are described below in conjunction with the appended drawing figures, wherein like reference numerals refer to like elements in the various figures, and wherein:

FIG. 1 is a block diagram illustrating components of a hearing prosthesis, according to an example;

FIG. 2 is a block diagram of components of a processing unit depicted in FIG. 1, according to an example;

FIG. 3 is a block diagram of components of an implanted unit depicted in FIG. 1, according to an example;

FIG. 4A is a block diagram of a system for processing an audio signal, according to an example;

FIGS. 4B-4E are block diagrams of examples of a channel selection module depicted in FIG. 4A;

FIGS. 5A-5F are graphs of spectral components of a spectral signal and threshold energies;

FIG. 6 is a flow diagram of a method for selecting one or more spectral components used to generate a stimulation signal, according to a first example;

FIG. 7 is a flow diagram of a method for selecting one or more spectral components used to generate a stimulation signal, according to a second example; and

FIG. 8 is a flow diagram of a method for adjusting a threshold energy level, according to an example.

### DETAILED DESCRIPTION

The following detailed description describes various features, functions, and attributes of the disclosed systems, methods, and devices with reference to the accompanying figures. In the figures, similar symbols typically identify similar components, unless context dictates otherwise. The illustrative embodiments described herein are not meant to be limiting. It will be readily understood that the aspects of the present disclosure, as generally described herein, and illustrated in the figures, can be arranged, substituted, combined, separated, and designed in a wide variety of different configurations, all of which are contemplated herein.

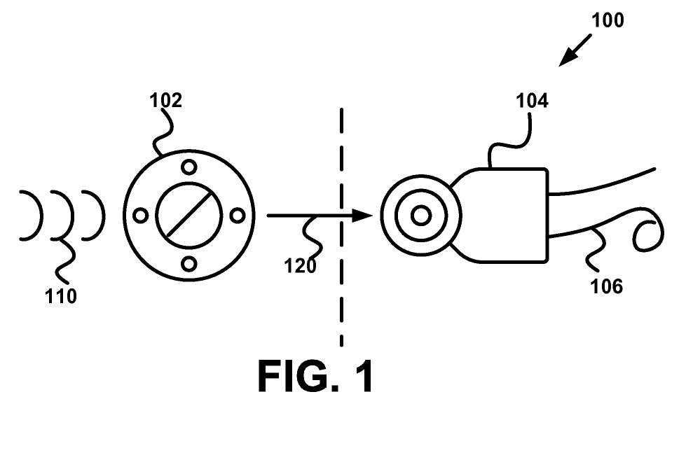

FIG. 1 illustrates a hearing prosthesis 100. The hearing prosthesis 100 includes a processing unit 102 and an implanted unit 104.

A recipient utilizes the hearing prosthesis 100 to assist the recipient in perceiving a sound. In FIG. 1, the hearing prosthesis 100 is a partially implantable cochlear implant. The processing unit 102 is external to the recipient's body, and the implanted unit 104 is implanted in the recipient's body.

In another example, the hearing prosthesis 100 is a totally implantable cochlear implant. In this example, the processing unit 102 and the implanted unit 104 are implanted in the recipient's body. Additionally, a single enclosure may contain the components of the processing unit 102 and the implanted unit 104.

In yet another example, the hearing prosthesis 100 is an auditory brain stem implant or any other hearing prosthesis or combination of hearing prostheses now known (e.g., a hearing prosthesis system combining electrical and mechanical stimulation) or later developed.

The processing unit 102 receives a sound 110. In one example, the sound 110 originates from a source in an environment. In another example, the sound 110 originates from an external device configured to send the sound signal to the processing unit 102, such as an audio streaming device. The processing unit 102 processes the sound 110 and generates a stimulation signal based on the sound 110.

Each stimulation signal is based on a number of spectral components of a digital sample of the sound 110. As used herein, the term “spectral component” refers to the energy of a sample of an audio signal at a given frequency or for a given frequency channel. When processing the sound 110, the processing unit 102 determines M spectral components of a sample of the sound 110, where M is a positive integer. Each of the M spectral components corresponds to one of the M frequency channels.

In a traditional channel selection technique, each input spectral component is compared to the other input spectral components in order to select the N input spectral components having the highest energy. For instance, if N is ten and M is twenty-two, each stimulation signal includes the N highest-energy spectral components of a given sample. In this manner, each sample of the sound 110 is processed in substantially the same manner.

Unlike processing units configured according to traditional channel selection techniques, the processing unit 102 is configured to process a narrowband signal (e.g., speech from an individual in a quiet environment) differently than a broadband signal (e.g., music in an arena or amphitheater). Because each input spectral component is compared to a threshold energy, as opposed to other spectral components, a stimulation signal for a narrowband signal may be based on fewer than N stimulation spectral components. Similarly, a stimulation signal for a broadband signal may be based on more than N spectral components.

To determine which of the M spectral components from which to generate the stimulation signal, the processing unit 102 compares an energy of a spectral component of a frequency channel to a threshold energy of that frequency channel. As used herein, the term “threshold energy” refers to an energy of a spectral component in a given frequency channel needed to include information indicative of that spectral component in a stimulation signal. In other words, the threshold energy for a frequency channel is a cut-off energy.

The threshold energies for the M frequency channels are determined such that, in a reference acoustic environment, an average of the number of spectral components included or represented in each stimulation signal is within a tolerance of N. In one example, the threshold energy for each frequency channel is determined at the point of manufacture of the processing unit 102.

In another example, the threshold energy for each frequency channel is determined by the processing unit 102, or by an audiologist or similar specialist, when “fitting,” or calibrating, the hearing prosthesis 100 for the recipient. If there is a group of one or more frequency channels that a given recipient does not process well (i.e., the recipient is unlikely to perceive a sound at frequency corresponding to each of the one or more frequency channels), the fitting results in higher threshold energies for the frequency channels in the group, as compared to frequency channels that the recipient does process well. Since the threshold energies for the frequency channels in the group are relatively higher, the processing unit 102 is less likely to include information indicative of spectral components in these frequency channels in the stimulation signal. And by extension, the processing unit 102 is more likely to include information indicative of spectral components in the frequency channels that the recipient does process well, thereby improving the temporal resolution for these frequency channels.

In yet another example, the threshold energy for each frequency channel depends on an operating mode of the processing unit 102. In one example, the processing unit 102 operates in one of two operating modes. In a first mode, the threshold energies for the M frequency channels are based on the reference acoustic environment. In a second operating mode, the threshold energies for frequency channels having a center frequency that is outside of a range of frequencies of human speech are higher than the threshold energies for frequency channels having a center frequency that is within the range of frequencies of human speech.

The recipient may cause processing unit 102 to operate in the second operating mode when the recipient is engaged in a conversation in a loud acoustic environment. Since the threshold energies for frequency channels outside of the range of frequencies of human speech are higher than in the first operating mode, the processing unit 102 is less likely to include information indicative of spectral components in these frequency channels in the stimulation signal. This may improve the recipient's ability to perceive speech since there is less background noise, and it may also improve the temporal resolution of the speech.

If the energy of a spectral component is less than a corresponding threshold energy, the stimulation signal does not include information indicative of that spectral component. The processing unit 102 generates the stimulation signal based on each spectral component having an energy that is greater than or equal to a corresponding threshold energy.

The processing unit 102 also provides a power signal to the implanted unit 104. The processing unit 102 modulates the power signal based on the stimulation signal such that a modulated power signal 120 contains both the power signal and the stimulation signal. In one example, the processing unit 102 inductively transfers the modulated power signal 120 to the implanted unit 104. In another example, the processing unit 102 transmits the modulated power signal 120 to the implanted unit 104 using a different transmission technique.

The implanted unit 104 receives the modulated power signal 120 and separates the modulated power signal 120 into the stimulation signal and the power signal. The implanted unit 104 generates one or more stimuli based on the stimulation signal and delivers the one or more stimuli to a body part in an auditory pathway of the recipient.

In the example of FIG. 1, in which the hearing prosthesis 100 is a partially implantable cochlear implant, the implanted unit 104 includes an electrode array 106 that is implanted in one of the recipient's cochleae. Upon receiving the stimulation signal, the implanted unit 104 generates one or more electrical signals based on the stimulation signal.

The implanted unit 104 sends one or more electrical signals to the electrode array 106, which causes one or more electrodes included on the electrode array 106 to deliver one or more electrical stimuli to the recipient's cochlea. Stimulating the recipient's cochlea causes the recipient to perceive at least a portion of the sound 110.

In an example in which the hearing prosthesis 100 is not a cochlear implant, the implanted unit 104 includes a component that is implanted (or otherwise placed) in one of the recipient's auditory nerves, the recipient's brain, or any other body part capable of being stimulated to assist the recipient in perceiving at least a portion of a sound. Delivering a stimulus to the body part stimulates the body part, allowing the recipient to perceive at least a portion of the sound 110.

Because the stimulation signal includes spectral components having an energy that is greater than a threshold energy, the resulting stimulus may improve the recipient's perception of both narrowband and broadband sounds. For instance, consider a plurality of stimulation signals for a narrowband sound, with each stimulation signal having fewer than N spectral components. In this example, the channel stimulation rate increases, thereby improving the temporal resolution of the sound perceived by the recipient (as compared to a stimulation signal processed according to traditional channel selection techniques).

In an example in which the stimulation signals are based on a broadband sound, the number of spectral components for each stimulation signal is greater than N. The spectral resolution of the resulting stimuli is improved (again, as compared to a stimulation signal processed according to traditional channel selection techniques).

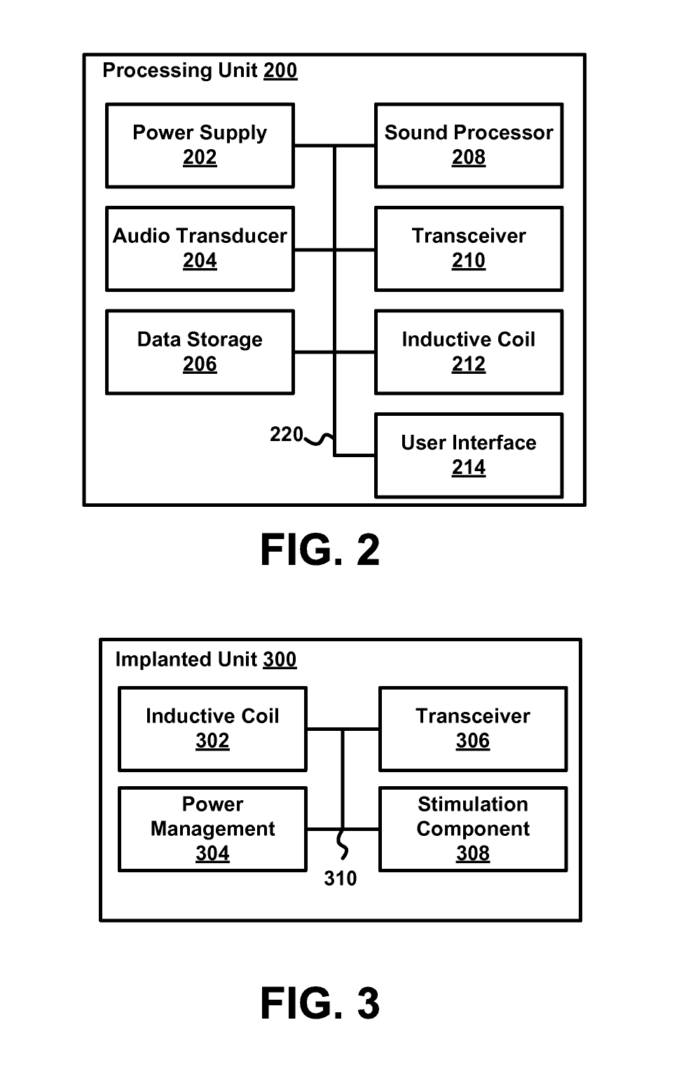

FIG. 2 is a block diagram of a processing unit 200. The processing unit 200 is one example of the processing unit 102 depicted in FIG. 1. The processing unit 200 includes a power supply 202, an audio transducer 204, a data storage 206, a sound processor 208, a transceiver 210, an inductive coil 212, and a user interface 214, all of which may be connected directly or indirectly via circuitry 220. For illustrative purposes, the processing unit 200 is the processing unit 102 depicted in FIG. 1.

The power supply 202 supplies power to various components of the processing unit 200 and can be any suitable power supply, such as a rechargeable or non-rechargeable battery. The power supply 202 also provides power to the implanted unit 104 via the inductive coil 212. In one example, the power supply 202 is a battery that can be charged wirelessly, such as through inductive charging. In another example, the power supply 202 is any power source now known or later developed that is suitable for use in the processing unit 200.

The audio transducer 204 receives the sound 110 from a source in an environment and sends a sound signal to the sound processor 208 that includes information indicative of the sound 110. In one example, the processing unit 200 is a component of a cochlear implant. In this example, the audio transducer 204 includes one or more microphones.

In another example, the processing unit 200 is a component of any hearing prosthesis or combination of hearing prostheses now known or later developed that is suitable for assisting a recipient of the hearing prosthesis 100 in perceiving the sound 110. In this example, the audio transducer 204 is an omnidirectional microphone, a directional microphone, an electro-mechanical transducer, and/or any other audio transducer now known or later developed suitable for use in the type of hearing prosthesis employed. Furthermore, in other examples the audio transducer 204 includes one or more additional audio transducers.

The data storage 206 includes any type of non-transitory, tangible, computer-readable media now known or later developed configurable to store program code for execution by a component of the processing unit 200 and/or other data associated with the processing unit 200. The data storage 206 stores information used by the sound processor 208 to process the sound signal, such as information indicative of one or more threshold energies. The data storage 206 may also store one or more computer programs executable by the sound processor 208.

The sound processor 208 is configured to determine a stimulation signal suitable for causing the implanted unit 104 to deliver one or more stimuli to a body part in one of the recipient's auditory pathways. In one example, the sound processor 208 includes one or more digital signal processors. In another example, the sound processor 208 is any processor or combination of processors now known or later developed suitable for use in a hearing prosthesis. Additionally, the sound processor 208 may include additional hardware for processing the sound signal, such as an analog-to-digital converter and/or one or more filters.

The sound processor 208 generates the stimulation signal by processing the sound signal received from the audio transducer 204. The stimulation signal includes information indicative of a stimulus current for one or more of the electrodes included on the electrode array 106. In order to generate the stimulation signal, the sound processor 208 determines an operating mode. In one example, the sound processor 208 is configured to determine the operating mode based on the sound signal. In another example, the sound processor 208 receives an input signal from the user interface 214 that includes information indicative of a user-selected operating mode.

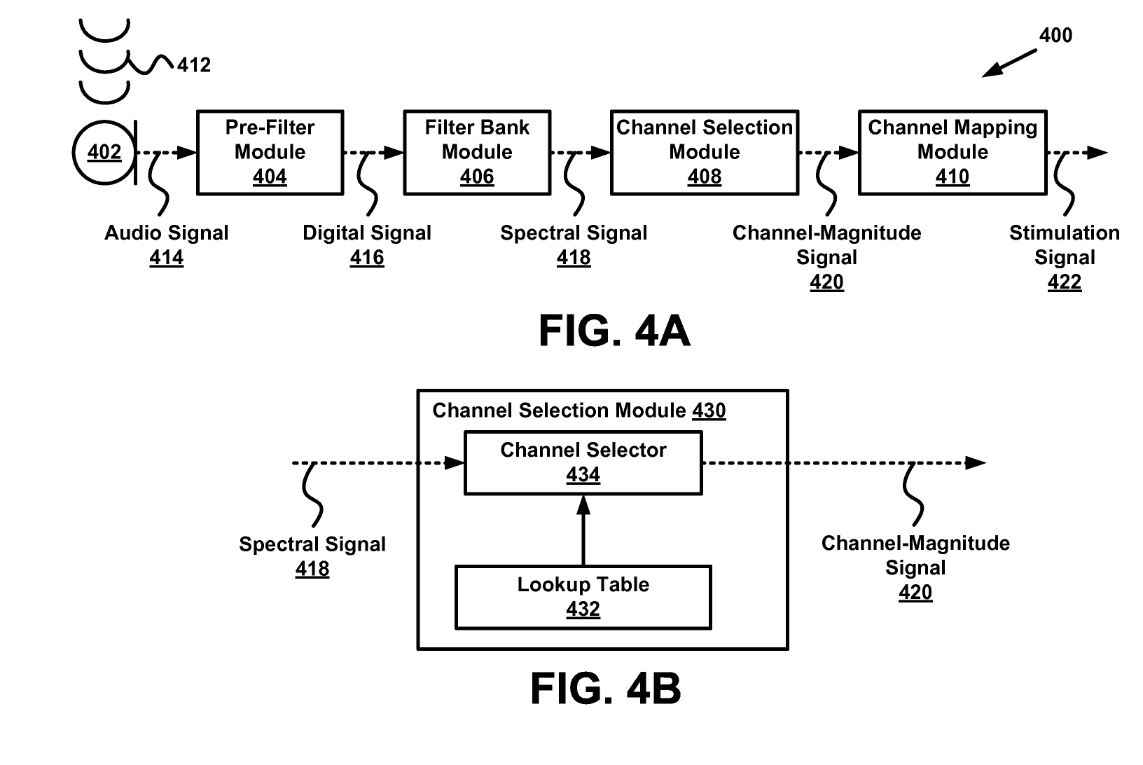

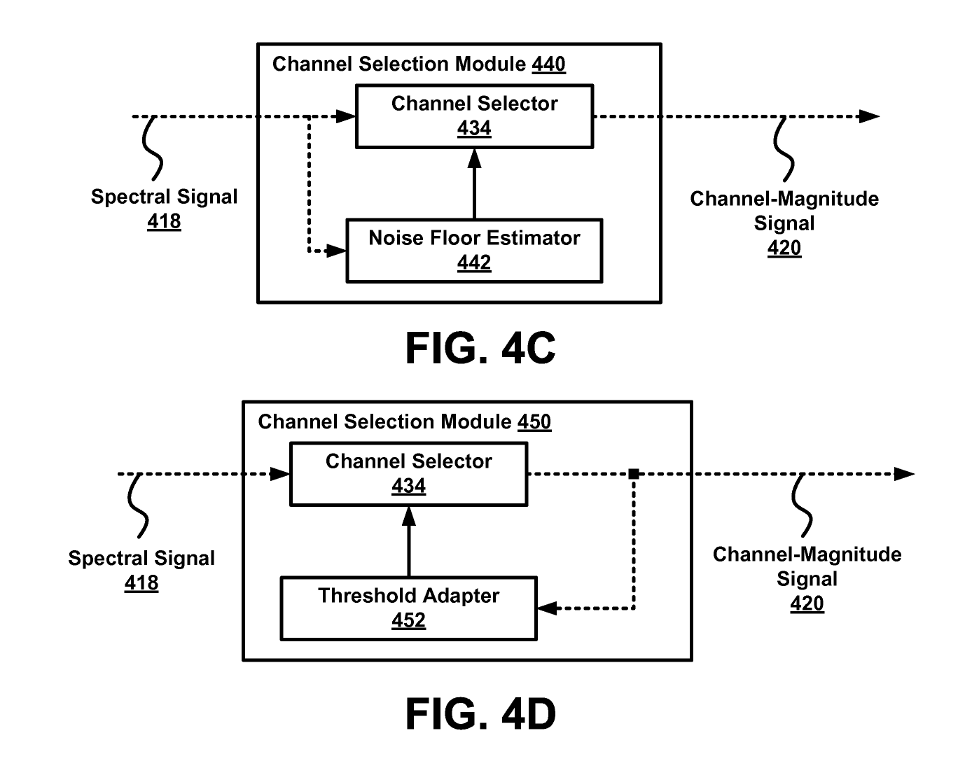

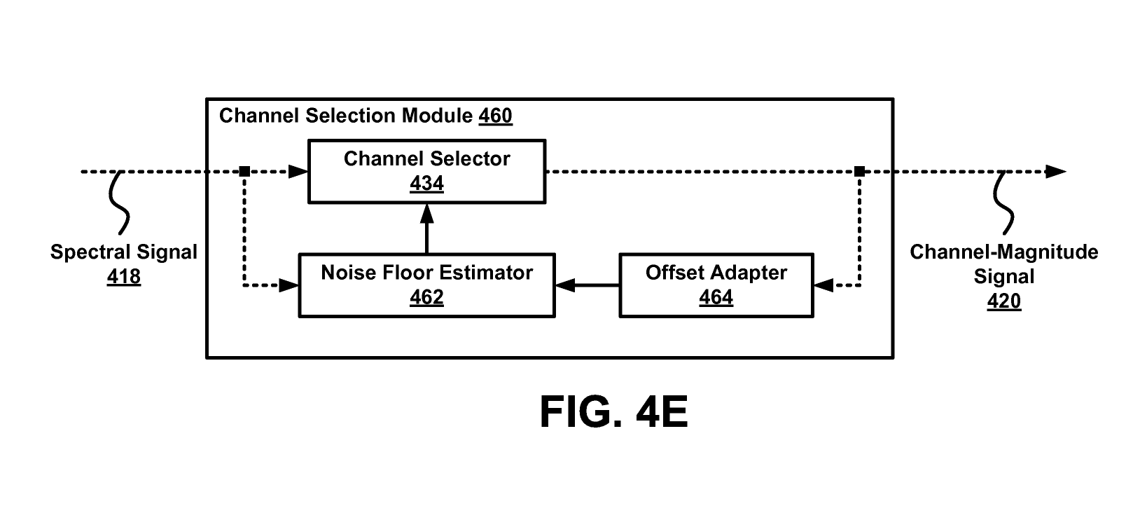

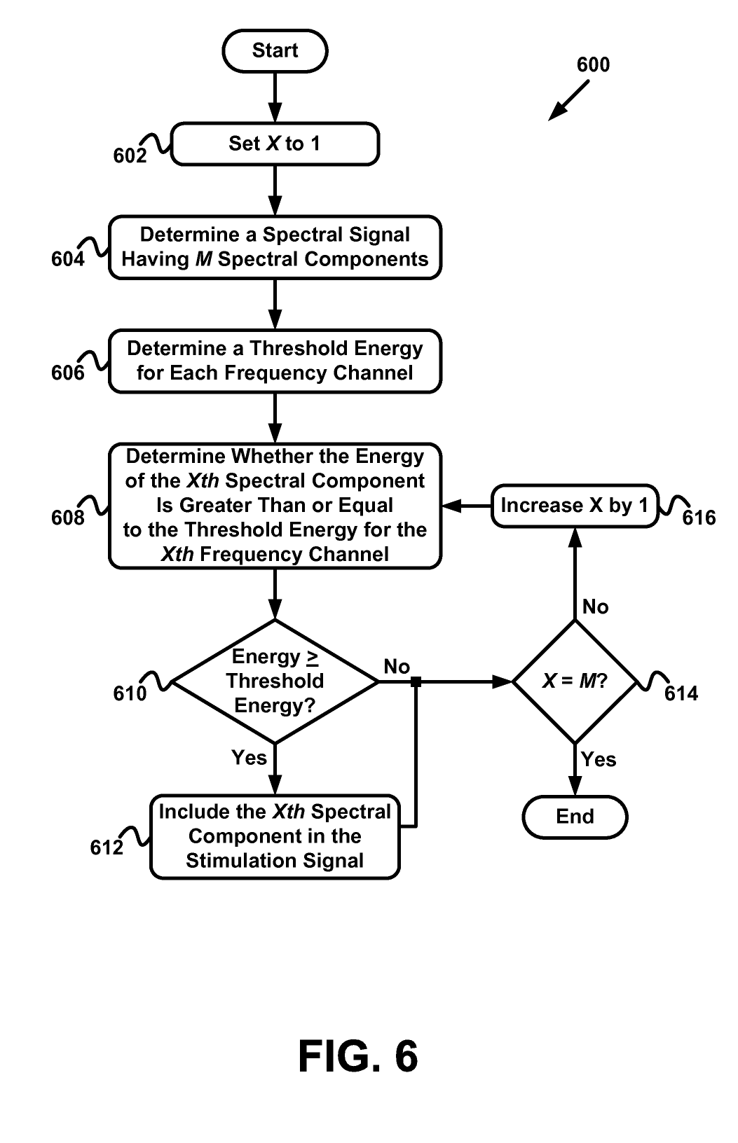

In one example, the sound processor 208 processes the sound signal as described herein with respect to the system described in FIG. 4A. Additionally, the sound processor 208 accesses the data storage 206 to retrieve one or more computer programs that cause the sound processor 208 to execute at least a portion of the methods described herein with respect to FIGS. 6-8.

The transceiver 210 receives the stimulation signal from the sound processor 208 and modulates the stimulation signal with the power signal to form the modulated power signal 120. In one example, the transceiver 210 modulates the stimulation signal with the power signal using a time-division multiple-access modulation scheme. In another example, the transceiver 210 uses any modulation scheme now known or later developed suitable for inductively transmitting the stimulation signal and the power signal to the implanted unit 104.

The transceiver 210 sends the modulated power signal to the inductive coil 212, which inductively transmits the modulated power signal 120 to the implanted unit 104. The inductive coil 212 is constructed of any material or combination of materials suitable for inductively transferring the modulated power signal 120 to the implanted unit 104.

The user interface 214 generates an input signal in response to receiving an input from a user of the processing unit 200, such as the recipient or an audiologist. The user interface 214 includes one or more interactive input components capable of receiving an input from the user, such as one or more buttons or similar components. The user interacts with one or more of the one or more input components to cause the user interface 214 to generate the input signal.

The user interface 214 sends the input signal to the sound processor 208. In one example, the input signal includes information indicative of an operating mode of the sound processor 208. In another example, the input signal includes information indicative of a value of an adjustable variable used by the sound processor 208 to generate the stimulation signal.

FIG. 3A is a block diagram of an implanted unit 300 of a hearing prosthesis. The implanted unit 300 is one example of the implanted unit 104 depicted in FIG. 1. The implanted unit 300 includes an inductive coil 302, power management 304, a transceiver 306, and a stimulation component 308, all of which are connected directly or indirectly via circuitry 310. For illustrative purposes, the implanted unit 300 is the implanted unit 104 depicted in FIG. 1.

The inductive coil 302 inductively receives the modulated power signal 120 from the processing unit 102. The inductive coil 302 is constructed of any biocompatible material or combination of materials suitable for inductively receiving power from the processing unit 102. The inductive coil 302 transfers the power signal to the power management 304. The power management 304 distributes power to the components of the implanted unit 300. The power management 304 includes a component suitable for separating the modulated power signal 120 into the stimulation signal and the power signal.

The power management 304 sends the stimulation signal to the transceiver 306, which transfers the stimulation signal to the stimulation component 308. The stimulation component 308 generates one or more stimuli based on the stimulation signal. In one example, the stimulation component 308 includes a first subcomponent configured to generate the one or more stimuli and a second subcomponent configured to deliver the one or more stimuli to a body part in the recipient's auditory pathway, such as a cochlea, an auditory nerve, a region of a brain, and any other organ or body part capable of assisting a recipient in perceiving at least a portion of the sound 110. The first subcomponent generates the one or more stimuli and sends the one or more stimuli to the second subcomponent. The second subcomponent delivers the one or more stimuli to the body part of the recipient.

For instance, since the implanted unit 300 is the implanted unit 104 in the present example, the stimulation component 308 includes a signal generator and the electrode array 106. The signal generator generates one or more electrical signals based on the stimulation signal and sends the one or more electrical signals to the electrode array 106. The one or more electrical signals cause one or more of the electrodes included on the electrode array 106 to deliver one or more electrical stimuli to a portion of the recipient's cochlea. The one or more electrical stimuli cause the cochlea to stimulate an auditory nerve, thereby allowing the recipient to perceive at least a portion of the sound 110.

FIG. 4A is a block diagram of a system 400 for processing an audio signal. The system 400 includes an audio transducer 402, a pre-filter module 404, a filter bank module 406, a channel selection module 408, and a channel mapping module 410. For illustrative purposes, the system 400 is described with reference to the processing unit 200.

The audio transducer 402 is the same as or is substantially similar to the audio transducer 204. In one example, the sound processor 208 includes hardware and/or software configurable to perform the operations described with respect to the modules 404-410. In another example, the processing unit 200 includes one or more additional components configured to assist the sound processor 208 in performing the operations described with respect to the modules 404-410. For instance, if the sound processor 208 performs the operations described with respect to modules 406-410, the processing unit 200 includes an additional component configured to perform the operations described with respect to the pre-filter module 404.

The audio transducer 402 receives a sound 412 from the environment. The audio transducer 402 sends an audio signal 414 that includes information indicative of the sound 412 to the pre-filter module 404. The pre-filter module 404 includes an amplifier configured to amplify high frequency components of the audio signal 414.

The pre-filter module 404 is also configured to employ an adaptive gain control. The adaptive gain control accounts for variations in an amplitude of the audio signal 414. The pre-filter module 404 further includes an analog-to-digital converter suitable for digitizing the audio signal 404. In one example, the analog-to-digital converter uses a sampling rate of 16 kHz to generate a 16-bit digital signal. In another example, a different sampling rate and/or bit representation is used when digitizing the audio signal 414.

The output of the pre-filter module 404 is a digital signal 416. The filter bank module 406 receives the digital signal 416 and generates a spectral signal 418 that includes one or more spectral components of the digital signal 416. A spectral component of the digital signal 416 is an energy of the digital signal 416 at a frequency or range of frequencies corresponding to a frequency channel. In one example, frequency channels are linearly spaced below 1 kHz and logarithmically spaced above 1 kHz. In another example, the frequency channels are spaced according to any scheme suitable for processing the digital signal 416.

In one example, the filter bank module 406 determines M spectral components corresponding to M frequency channels, with M being an integer greater than one. For a cochlear implant, M may correspond to a number of electrodes included on an electrode array. That is, if there are twenty-two electrodes included on the electrode array, there are twenty-two frequency channels, with each frequency channel corresponding to one of the electrodes. Alternatively, M may be greater than or less than twenty-two, and may depend on a quantity of surviving neurons in the recipient's cochlea. For another type of hearing prosthesis, the value of M is any integer suitable for generating a stimulation signal.

The filter bank module 406 includes a band-pass filter and an envelope detector for each of M frequency channels. In one example, each band-pass filter is implemented using a Fast Fourier Transform (“FFT”), with each frequency channel corresponding to one or more FFT bins. In another example, each band-pass filter is implemented via circuitry in the sound processor 208, or perhaps another component of the processing unit 102. In yet another example, each band-pass filter is implemented using any method or device now known or later developed that is suitable for determining a spectral component of the digital signal 416.

A portion of the digital signal 416 passes through each band-pass filter, and an associated envelope detector determines an envelope of the portion of the digital signal 416. The output of each envelope detector is based on an envelope of a portion of the digital signal 416 that passes through an associated band-pass filter. For instance, if a band-pass filter is implemented using an FFT, an associated envelope detector determines the envelope for the frequency channel based on the energy of the one or more FFT bins associated with the frequency channel.

In one example, the output of each envelope detector is an energy corresponding to a center frequency of the associated band-pass filter. In another example, the output of each envelope detector is a maximum energy or an average energy of the envelope. The filter bank module 406 generates the spectral signal 418 based on the outputs of the M envelope detectors.

The channel selection module 408 receives the spectral signal 418 and generates a channel-magnitude signal 420. The channel-magnitude signal 420 includes one or more spectral components of the digital signal 418 that will be used to generate a stimulation signal 422. To generate the channel-magnitude signal 420, the channel selection module 408 includes components configured to compare the energy of each spectral component to one or more threshold energies.

FIGS. 4B-4E are block diagrams of examples of the channel selection module 408 depicted in FIG. 4A. A component of the processing unit 102, such as the sound processor 208 implements one, or perhaps more than one, of the channel selection modules depicted in FIGS. 4B-4E when implementing the system 400.

FIG. 4B is a block diagram of a channel selection module 430. The channel selection module 430 includes a lookup table 432 and a channel selector 434.

The lookup table 432 stores information indicative of one or more threshold energies. In one example, the lookup table 432 represents a portion of the data storage 206. In another example, the lookup table 432 is a separate data storage device or component that is the same as or is substantially similar to the data storage 206.

The channel selector 434 accesses the lookup table 432 to identify the one or more threshold energies. The channel selector 434 receives the spectral signal 418 and compares each spectral component of the spectral signal 418 to one of the one or more threshold energies. The channel selector 434 includes each spectral component that has an energy that is greater than or equal to an associated threshold energy in the channel-magnitude signal 420.

In one example, the lookup table 432 stores information indicative of a single threshold energy. The channel selector 434 accesses the lookup table 432 to identify the single threshold energy. The channel selector 434 compares the energy of each of the M spectral components of the spectral signal 418 to the single threshold energy.

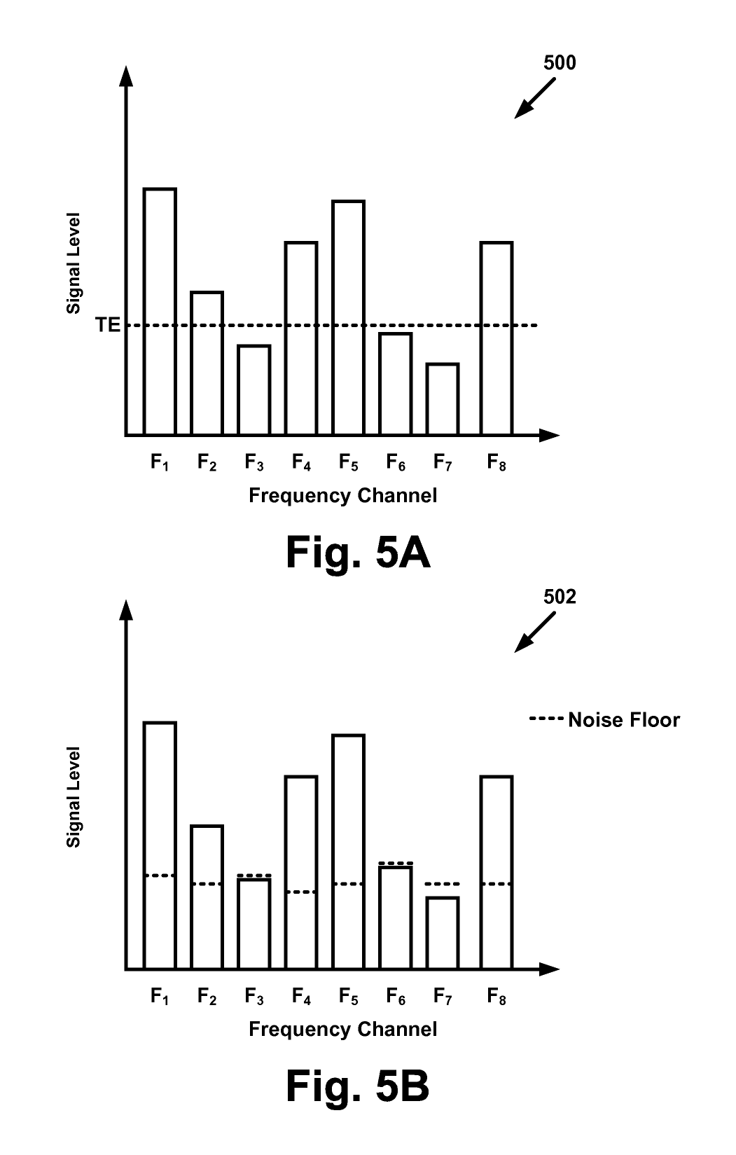

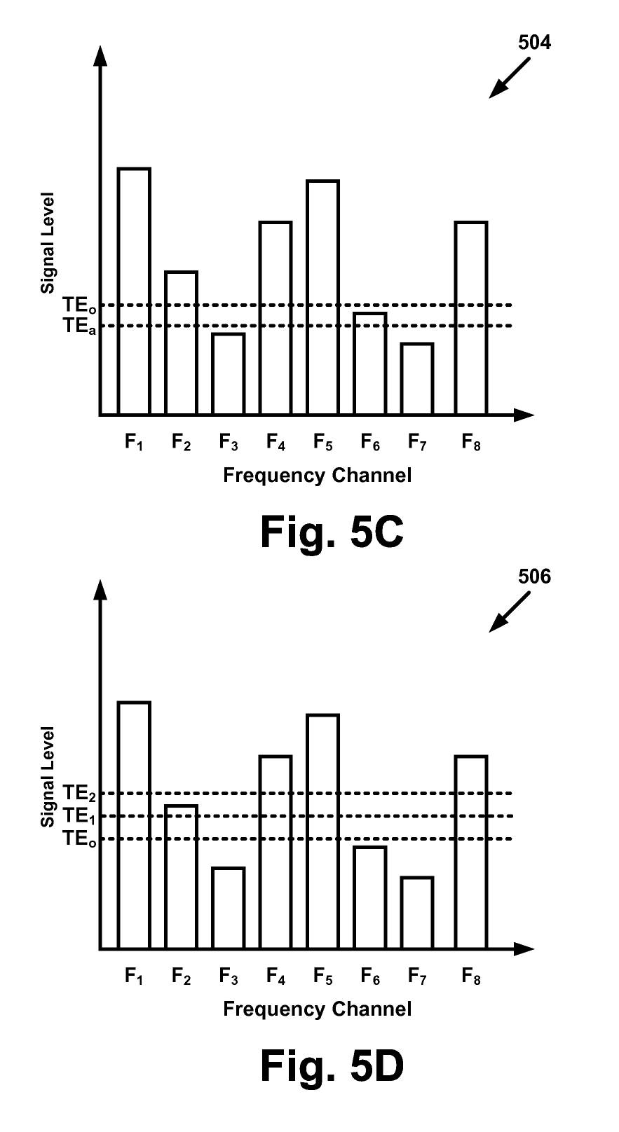

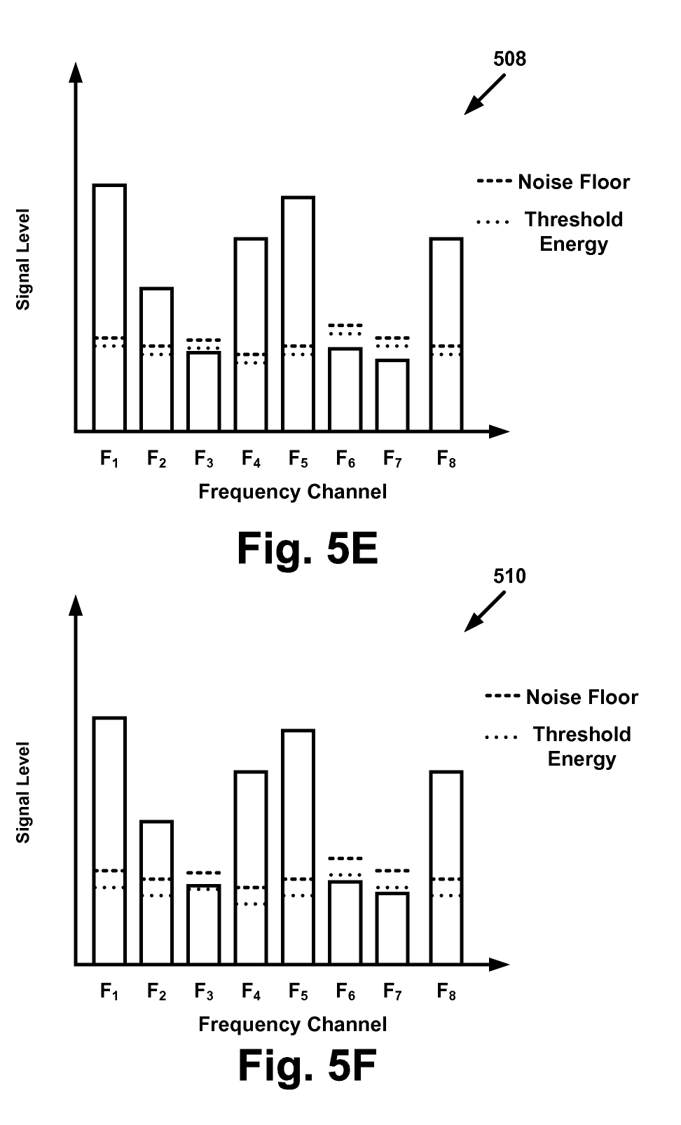

FIG. 5A is a graph 500 of spectral components of the spectral signal 418 and a threshold energy. For illustrative purposes, the graph 500, as well as the graphs depicted in FIGS. 5B-5F, depicts the energies of spectral components of the spectral signal 418 in eight frequency channels F₁-F₈. In practice, the spectral signal 418 may include more than eight frequency channels, such as twenty-two frequency channels, or perhaps fewer than eight frequency channels.

As depicted in the graph 500, the threshold energy TE is the threshold energy for each of the frequency channels F₁-F₈. For each of the frequency channels, the channel selector 434 compares the energy of the spectral component to the threshold energy TE. The channel selector 434 includes each spectral component that has an energy that is greater than or equal to the threshold energy TE in the channel-magnitude signal 420.

In the example depicted in FIG. 5A, the channel selector 434 determines that the energies of the spectral components for frequency channels F₁, F₂, F₄, F₅, and F₈ are greater than the threshold energy TE. As a result, the channel selector 434 includes the spectral components for frequency channels F₁, F₂, F₄, F₅, and F₈ in the channel-magnitude signal 420.

In another example, the lookup table 432 stores information indicative of M threshold energies, with each threshold energy corresponding to one of the M frequency channels. In this example, the channel selector 434 accesses the lookup table 432 to identify the M threshold energies. For each of the M frequency channels, the channel selector 434 compares the energy of the spectral component at a frequency channel to the threshold energy of that frequency channel.

Alternatively, the channel selector 434 accesses the lookup table 432 prior to each individual comparison of a spectral component to a threshold energy. That is, rather than identifying each of M threshold energies at once, the channel selector 434 access the lookup table 432 to identify the threshold energy of the frequency channel currently being evaluated. For instance, if the channel selector 434 is evaluating the spectral component for a ninth frequency channel, the channel selector 434 accesses the lookup table 432 to identify the threshold energy for the ninth frequency channel.

In yet another example, the lookup table 432 stores X threshold energies, where X is a positive integer less than M. In this example, each of the threshold energies corresponds to one or more frequency channels. For instance, if X is three and M is nine, a first threshold energy may correspond to frequency channels 1-3, a second threshold energy may correspond to frequency channels 4-6, and a third threshold energy may correspond to frequency channels 7-9. While each threshold energy in this example corresponds to three frequency channels, it is understood that a given threshold energy may correspond to more or fewer frequency channels. The channel selector 434 accesses the data storage to identify the X threshold energies, and compares each of the M spectral components to an associated threshold energy.

In still another example, the lookup table 432 stores one or more sets of threshold energies, with each set corresponding to an operating mode. For instance, consider an example in which the lookup table 432 stores two sets of threshold energies. A first set of threshold energies corresponds to a first operating mode, and a second set of threshold energies corresponds to a second operating mode.

The first set of threshold energies includes a threshold energy for each of the M frequency channels, which is approximately the same threshold energy. The second set of threshold energies includes a threshold energy for two groups of the M frequency channels. The first group includes frequency channels having a center frequency that is outside of the range of frequencies of human speech, and the second group includes frequency channels having a center frequency that is within the range of frequencies of human speech. The threshold energies for the frequency channels in the first group are higher than the threshold energies for the frequency channels in the second group. Additionally, the threshold energies for the frequency channels in the first group are also higher than the threshold energies of these frequencies channels in the first set of threshold energies.

In this example, the channel selector 434 determines the operating mode of the processing unit 200. Depending on the determined operating mode, the channel selector 434 accesses either the first set of threshold energies or the second set of threshold energies from the lookup table 432 to identify the information indicative of the one or more threshold energies.

FIG. 4C is a block diagram of a channel selection module 440. The channel selection module 440 includes a noise floor estimator 442, as well as the channel selector 434 described with respect to FIG. 4B.

The noise floor estimator 442 receives the spectral signal 418 and determines a noise floor for each of the M frequency channels. The noise floor for a frequency channel is the energy of a spectral component corresponding to the frequency channel that is attributable to noise. To determine a noise floor for a given frequency channel, the noise floor estimator 442 uses any method or algorithm now known or later developed that is suitable for determining the noise floor of a frequency channel of a hearing prosthesis.

In one example, the noise floor estimator 442 estimates a noise floor for each of the M frequency channels. For each frequency channel, the noise floor estimator 442 determines that the noise floor of a frequency channel is that frequency channel's threshold energy. The noise floor estimator 442 sends information indicative of the threshold energy for each of M frequency channels to the channel selector 434.

FIG. 5B is a graph 502 of spectral components of a spectral signal and threshold energies. The graph 502 includes an indication of the noise floors for each of the eight frequency channels F₁-F₈ as estimated by the noise floor estimator 442. In this example, the noise floor estimator 442 determines that the noise floor for each frequency channel is the threshold energy for that frequency channel.

The channel selector 434 determines whether each spectral component is greater than or equal to the threshold energy for that channel (i.e., the energy of the spectral component is greater than or equal to the noise floor). In the example illustrated by the graph 502, the channel selector 434 determines that the spectral components for frequency channels F₁, F₂, F₄, F₅, and F₈ are greater than or equal to the threshold energy for the respective frequency channels. Consequently, the channel selector 434 includes the spectral components for frequency channels F₁, F₂, F₄, F₅, and F₈ in the channel-magnitude signal 420.

In another example, the noise floor estimator 442 determines the one or more threshold energies based on one or more statistics of the estimated noise floors for one or more groups of frequency channels. The one or more statistics may include, for each of one or more groups of frequency channels, an average noise floor, a maximum noise floor, a minimum noise floor, a median noise floor, or any other statistic suitable for use by the channel selection module 440.

For instance, consider an example in which the statistic is an average and a first group of frequency channels includes the first frequency channel through the fourth frequency channel. The noise floor estimator 442 estimates the noise floors for each of the first frequency channel through the fourth frequency channel, and then determines the average of the estimated noise floors. The noise floor estimator 442 determines that the average noise floor is the threshold energy for each of the first frequency channel through the fourth frequency channel, and sends information indicative of the threshold energies of the first frequency channel through the fourth frequency channel to the channel selector 434.

In yet another example, the noise floor estimator 442 determines the threshold energy for one or more frequency channels based on the estimated noise floor of an adjacent channel. For example, if the noise floor estimator 442 estimates the noise floor for the third frequency channel, the noise floor estimator 442 then determines that the threshold energy of the second frequency channel and the fourth frequency channel is the noise floor for the third frequency channel.

In still another example, the noise floor estimator 442 determines that the threshold energy of a given frequency channel is the noise floor plus an offset. Applying an offset to the M noise floors may account for potential errors in determining the noise floor and/or limit the number of spectral components included in the channel-magnitude signal 420. In one example, an offset applied to the noise floor of each frequency channel is approximately constant. In another example, each frequency channel has an individual offset. In yet another example, an offset is applied to each frequency channel in a group of frequency channels.

FIG. 4D is a block diagram of a channel selection module 450. The channel selection module 450 includes a threshold adapter 452, as well as the channel selector 434 described with respect to FIG. 4B.

As previously described, the threshold energy is determined such that N spectral components are included, on average, in the channel-magnitude signal 420 in a normal acoustic environment. Since the number of spectral components included in the channel-magnitude signal 420 may be more or less than N when the recipient is not in the normal acoustic environment, the threshold adapter 452 is configured to adjust the threshold energy for one or more frequency channels in order to maintain an average number of spectral components in the channel-magnitude sequence.

The threshold adapter 452 receives the channel-magnitude signal 420 from the channel selector 434 and determines a number of spectral components included in the channel-magnitude signal 420.

The threshold adapter 452 determines whether the number of spectral components is equal to a target number of spectral components. If the number of spectral components is equal to the target number, the threshold adapter 452 does not adjust the one or more threshold energies. If the threshold adapter 452 determines that the number of spectral components is greater than the target number, then the threshold adapter 452 increases the one or more threshold energies. In contrast, the threshold adapter 452 decreases the one or more threshold energies if the threshold adapter 452 determines that the number of spectral components is less than the target number of spectral components.

FIG. 5C is a graph 504 of spectral components and threshold energies. The graph 504 illustrates a first example application of the channel selection module 450. In this example, the target number is six.

An initial threshold energy TEₒ represents an unadjusted threshold energy. If using the initial threshold energy TEₒ, the channel selector 434 would determine that the spectral components for frequency channels F₁, F₂, F₄, F₅, and F₈ are greater than or equal to the initial threshold energy TEₒ. Thus, the number of spectral components (five) included in the channel-magnitude signal 420 for this sample is less than the target number (six).

The threshold adapter 452 determines that the number spectral components included in the channel-magnitude signal 420 the target number and reduces the threshold energy from the initial threshold energy TEₒ to an adjusted energy TEₐ.

The threshold adapter 452 sends information indicative of the adjusted energy TEₐ to the channel selector 434. By using the adjusted threshold energy TEₐ, the channel selector 434 may include more spectral components in the channel-magnitude signal 420 than if the initial threshold energy TEₒ were used. In the example illustrated by the graph 504, the channel selector 434 would determine that the spectral components for frequency channels F₁, F₂, F₄, F₅, F₆, and F₈ are greater than or equal to the adjusted threshold energy TE₁. Thus, the number of spectral components included in the channel-magnitude signal 420 would equal the target number.

FIG. 5D is a graph 506 of spectral components and threshold energies. The graph 506 illustrates a second example application of the channel selection module 450. In this example, the target number is four.

As in FIG. 5C, the initial threshold energy TEₒ represents an unadjusted threshold energy. If the initial threshold energy TEₒ is used, the channel selector 434 would determine that the spectral components for frequency channels F₁, F₂, F₄, F₅, and F₈ are greater than or equal to the initial threshold energy TEₒ. Thus, the number of spectral components included in the channel-magnitude signal 420 for this sample is greater than the target number.

In a first example application, the threshold adapter 452 determines that the number of spectral components included in the last channel-magnitude signals 420 is greater than four. The threshold adapter 452 determines that the number of spectral is above the upper bound, and increases the threshold energy from the initial threshold energy TEₒ to a first adjusted energy TE₁.

The threshold adapter 452 sends information indicative of the adjusted energy TE₁ to the channel selector 434. Although the first adjusted energy TE₁ is greater than the initial threshold energy TEₒ, the number of spectral components included in the channel-magnitude signal 420 is still greater than the target number. That is, the channel selector 434 would determine that the spectral components for frequency channels F₁, F₂, F₄, F₅, F₆, and F₈ are greater than or equal to the adjusted threshold energy TE₁.

In a second example application, the threshold adapter 452 raised the threshold energy to the first adjusted threshold energy TE₁ after a preceding interval. If the threshold adapter 452 determines that the number of spectral component included in the spectral signal 452 is still greater above the upper bound, then the threshold adapter 452 increases the threshold energy from the first adjusted threshold energy TE₁ to a second adjusted threshold energy TE₂.

The threshold adapter 452 sends information indicative of the second adjusted threshold energy TE₂ to the channel selector 434. Increasing the threshold energy to the second adjusted TE₂ further increases a likelihood that the number of spectral components included in the next channel-magnitude signal 420 will equal the target number. As illustrated by the graph 506, the channel selector 434 would determine that the spectral components for frequency channels F₁, F₄, F₅, F₆, and F₈ are greater than or equal to the adjusted threshold energy TE₂.

The amount of the increase or decrease applied to the one or more threshold energies depends on a slew rate. The slew rate is determined such that applying an adjustment to the one or more threshold energies results in a gradual change of the one or more threshold energies. In one example, the slew rate is pre-programmed at the point of manufacture. In another example, the audiologist determines the slew rate during the fitting process. In still another example, the slew rate is adjusted by sound processor 208 during, for example, a calibration operation. Additionally, the slew rate used to decrease the one or more threshold energies may be different than the slew rate used to increase the one or more threshold energies. This allows the sound processor 208 to gradually adapt to changes in the acoustic environment over time.

FIG. 4E is a block diagram of a channel selection module 460. The channel selection module 460 includes a noise floor estimator 462 and an offset adapter 464, as well as the channel selector 434 described with respect to FIG. 4B.

The channel selection module 460 is a combination of the channel selection module 440 depicted in FIG. 4C and the channel selection module 450 depicted in FIG. 4D. That is, the noise floor estimator 462 and the offset adapter 464 are the same as or are substantially similar to the noise floor estimator 442 depicted in FIG. 4C and the threshold adapter 452 depicted in FIG. 4D, respectively. In this example, the noise floor estimator 462 is configured to determine that a threshold energy for a frequency channel is an estimated noise floor for the frequency channel plus an offset received from the offset adapter 464.

Rather than adjusting the one or more threshold energies, the offset adapter 464 adjusts one or more offsets applied to the noise floors by the noise floor estimator 462. When the number of spectral components is not within a tolerance of the target number, the offset adjustor 464 determines the one or more offsets for the M noise floors and sends the one or more offsets to the noise floor estimator 462.

FIG. 5E is a graph 508 of spectral components of the spectral signal 418 and threshold energies. FIG. 5E is an example application of the channel selection module 460. In the examples illustrated by FIGS. 5E and 5F, the target number is six.

If the noise floor for each channel is used, the channel selector 434 would determine that the spectral components for frequency channels F₁, F₂, F₄, F₅, and F₈ are greater than or equal to the respective noise floors for those channels. In this example, the number of spectral components included in the channel-magnitude signal 420 for this sample is less than the target number.

In this example, the offset adapter 464 determines that the number of spectral components included in the last channel-magnitude signal 420 is less than the target number. In response, the offset adapter 464 sends information indicative of a first offset to the noise floor estimator 462. The noise floor estimator 462 estimates the noise floor for each of the frequency channels F₁-F₈. For each of the frequency channels F₁-F₈, the noise floor estimator then applies the first offset to the estimated noise floor of a frequency channel to determine the threshold energy of that frequency channel.

The resulting threshold energy for each frequency channel is less than the energy of the noise floor, thereby increasing a likelihood that six spectral components will be included in subsequent channel-magnitude signals 420. While using the threshold energies indicated on the graph 508 would still result in including fewer than the target number of spectral components in the channel-magnitude signal 420, it is more likely that, over the next interval, the average will be within a tolerance of the target number.

FIG. 5F is a graph 510 of spectral components of a sample of the spectral signal 418 and threshold energies. FIG. 5F is an example application of the channel selection module 460 at a next interval of the example application depicted in FIG. 5E. In this example, the offset adapter 464 determines that the number of spectral components included in the last channel-magnitude signal is still less than the target number.

In response, the offset adapter 464 sends the noise floor estimator 462 information indicative of a second offset for each of the frequency channels F₁-F₈. The second offset is about twice the first offset described with respect to FIG. 5E. The noise floor estimator 462 estimates the noise floor for each of the frequency channels F₁-F₈. To determine the threshold energy for each of the frequency channels F₁-F₈, the noise floor estimator 462 applies the second offset to each estimated noise floor.

The resulting threshold energies for the frequency channels F₁-F₈ are less than the threshold energies for the frequency channels F₁-F₈ depicted in FIG. 5E, thereby further increasing the likelihood that six spectral components will be included in subsequent channel-magnitude signals 420. As illustrated by the graph 510, applying the additional offset to the noise floors would result in the channel selector 434 determining that the spectral components for frequency channels F₁, F₂, F₃, F₄, F₅, and F₈ are greater than or equal to the respective noise floors for those channels. In this example, the number of spectral components included in the channel-magnitude signal 420 for this sample is now equal to the target number.

In the examples described with respect to FIGS. 5E and 5F, the offsets applied to each channel are about the same. In another example, each frequency channel, or perhaps one or more groups of frequency channels, has an individual offset. Furthermore, the threshold adapter may not increase or decrease the offset by the same amount during each adjustment.

In the preceding examples describing FIGS. 4B-4E, the channel selector 434 determines whether the energy of a spectral component is greater than or equal to the threshold energy when determining whether to include the spectral component in the channel-magnitude signal 420. In an alternative example, the channel selection modules 430, 440, 450, 460 include one or more buffers for the spectral signal 418 and/or the channel-magnitude signal 420.

Returning to FIG. 4A, the channel mapping module 410 receives the channel-magnitude signal 420 and generates a stimulation signal 422. When the hearing prosthesis provides electrical stimuli, the channel mapping module 410 determines a pulse set (fₙ, Iₙ) for each of the N spectral components included in the channel-magnitude sequence. Iₙ is a current for an electrode corresponding to the frequency channel fₙ.

As previously described, each of the M frequency channels corresponds to an electrode included on the electrode array 106. Each electrode has a mapping curve that indicates a stimulus current for the electrode as a function of the energy of a spectral component at a corresponding frequency channel. The mapping curves are determined when fitting the hearing prosthesis 100 to the recipient, which typically involves determining a threshold current (T-Level) and a maximum comfort level (C-Level) for each electrode. The T-Level is a stimulus current below which the recipient is unable to perceive a tone at a given frequency corresponding to the electrode. The C-Level is a stimulus current above which the recipient perceives the tone as being uncomfortably loud.

In one example, the current is zero if the energy of the spectral component is less than a minimum energy, the current varies approximately logarithmically between the T-Level and the C-Level when the energy of the spectral component is between the minimum energy and a maximum energy, and the current is the C-Level if the energy of the spectral component is greater than the maximum energy. For each spectral component included in the channel-magnitude sequence 420, the channel mapping module 410 identifies the current corresponding to the energy of a spectral component from a corresponding electrode's mapping curve.

The channel-mapping module 410 may arrange one or more pulse sets from high frequency to low frequency if N is greater than one. For example, if N is three, the stimulation signal 422 includes three pulse sets: (f₁, I₁), (f₂, I₂), and (f₃, I₃). If f₃ is greater than f₂ and f₂ is greater than f₁, the channel mapping module 410 arranges the pulse sets in the stimulation signal 422 in the following order: (f₃, I₃), (f₂, I₂), (f₁, I₁). The sound processor 208 then sends the stimulation signal 422 to the transceiver 210 for transmission to the implanted unit of the hearing prosthesis.

FIG. 6 is a flow diagram of a method 600 for selecting one or more spectral components used to generate a stimulation signal. A sound processor performs the steps of one or more blocks of the method 600 to generate a stimulation signal based on a digital sample of an audio signal. While the processing unit 200 is described for purposes of illustrating the method 600 and other methods described herein, it is understood that other devices may be used.

At block 602, the method 600 includes initializing a counter X to one. At block 604, the method 600 includes determining a spectral signal having M spectral components, where M is a positive integer corresponding to a number of frequency channels of the hearing prosthesis. In one example, the sound processor 208 determines the spectral signal by implementing the functions described with respect to the modules 404-406 of FIG. 4A. In another example, the sound processor 208 uses any process or combination of processes now known or later developed that is suitable for determining the spectral signal.

At block 606, the method 600 includes determining a threshold energy for each frequency channel. In one example, the sound processor 208 implements the channel selection module 430 depicted in FIG. 4B. To determine M threshold energies, the sound processor 208 accesses a data storage configured to implement the lookup table 432, such as the data storage 206.

In another example, the sound processor 208 implements the channel selection module 440 depicted in FIG. 4C. The sound processor 208 performs the functions described with respect to the noise floor estimator 442 to determine the M threshold energies.

In yet another example, the sound processor 208 implements the channel selection module 450 depicted in FIG. 4D. The sound processor 208 performs the function described with respect to the threshold adjuster 452 when determining the M threshold energies.

In still another example, the sound processor 208 implements the channel selection module 460 depicted in FIG. 4E. To determine the M threshold energies, the sound processor 208 implements the functions described with respect to the noise floor estimator 462 and the offset adapter 464.

At block 608, the method 600 includes determining whether the energy of the Xth spectral component is greater than or equal to the threshold energy for the Xth frequency channel. The sound processor 608 implements the functions described with respect to the channel selector 434 depicted in FIG. 4B when performing the steps of block 608.

At block 610, the method 600 includes a decision point. If the sound processor 208 determines that the energy of the Xth spectral component is greater than or equal to the threshold energy for the Xth frequency channel, the Xth spectral component is included in the stimulation signal at block, at block 612. Otherwise, the method 600 includes proceeding to block 614.

At block 614, the method 600 includes a decision point. If the counter X equals M, then the method 600 ends. If the counter X does not equal the number of frequency channels M, the method 600 includes increasing the counter X by one, at block 616. The sound processor 208 increases the counter X by one, which prepares the sound processor 208 to compare the spectral component for the next frequency channel to the threshold energy for the next frequency channel. After performing the steps of block 616, the method 600 includes returning to block 608.

In some examples, the sound processor 208 is configured to implement the method 600 in a manner such that multiple frequency channels are evaluated in parallel. For example, the sound processor 208 evaluates two frequency channels at the same time.

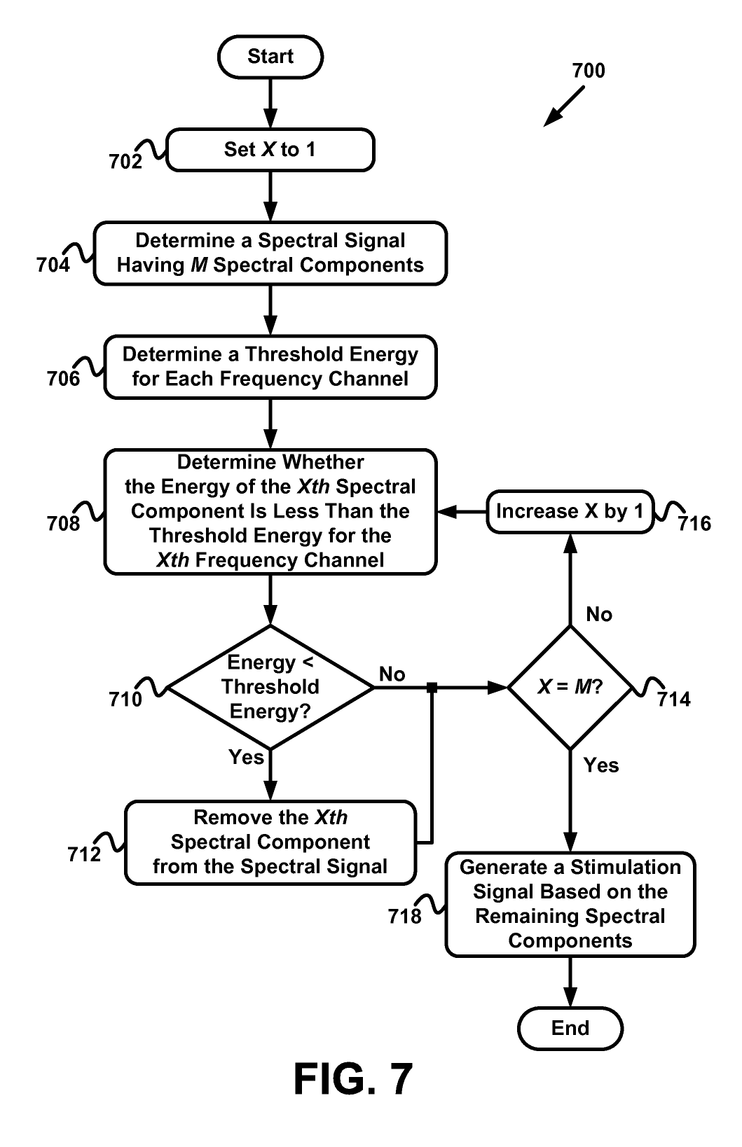

FIG. 7 is a flow diagram of a method 700 for selecting one or more spectral components used to generate a stimulation signal. A sound processor performs the steps of one or more blocks of the method 700 to generate a stimulation signal based on a digital sample of an audio signal.

At block 702, the method 700 includes initializing a counter X to one. At block 704, the method 700 includes determining a spectral signal having M spectral components. The sound processor 208 performs steps that are the same as or are substantially similar to the steps described with respect to block 604 when performing the steps of block 704.

At block 706, the method 700 includes determining a threshold energy for each frequency channel. To perform the steps of block 706, the sound processor 208 performs steps that are the same as or are substantially similar to the steps described with respect to block 606 of the method 600.

At block 708, the method 700 includes determining whether the energy of the Xth spectral component is less than the threshold energy for the Xth frequency channel. The sound processor 208 compares the energy of the Xth spectral component to the threshold energy for the Xth spectral component in order to determine whether the energy of the Xth spectral component is less than the threshold energy.

At block 710, the method 700 includes a decision point. If the energy of the Xth spectral component is less than the threshold energy for the Xth frequency channel, the method 700 proceeds to block 712. Otherwise, the method 700 proceeds to block 714.

At block 712, the method 700 includes removing the Xth spectral component from the spectral signal. The sound processor 208 removes the Xth spectral component from the spectral signal to perform the steps of block 712.

At block 714, the method 700 includes a decision point, which is the same as or is substantially similar to the decision point 614 described with respect to FIG. 7. If the counter X is less than M, the method 700 includes increasing the counter X by one, at block 714. The sound processor 208 performs the same or substantially similar steps when performing the steps of block 716 as described with respect to block 616 of the method 600. The method 700 then includes returning to block 708.

If the counter X equals M at block 714, the method 700 includes generating a stimulation signal based on the remaining spectral components of the spectral signal, at block 718. The sound processor 208 includes the remaining spectral components (i.e., the spectral components not removed from the spectral signal) in a channel-magnitude signal. The sound processor 208 then performs the functions of the channel mapping module 410 described with respect to FIG. 4A to generate the stimulation signal.

After completing the steps of block 714, the method 700 ends. As with the method 600, the sound processor 208 may perform iterations of the method 700 in parallel in order to evaluate multiple channels at the same time.

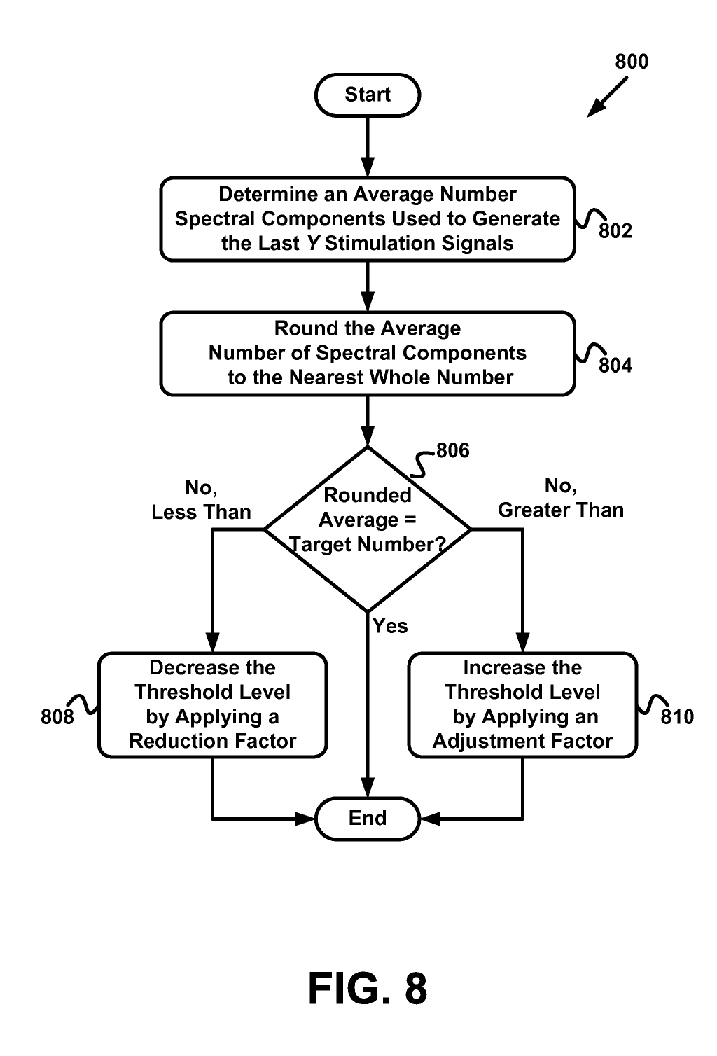

FIG. 8 is a flow diagram of a method 800 for adjusting a threshold energy level. A sound processor performs the steps of one or more blocks of the method 800 to increase a likelihood that an average number of spectral components included in a stimulation signal is within a tolerance of a target number.

The sound processor 208 performs the method 800 when implementing a channel selection module configured to adjust one or more threshold energies used to generate a stimulation signal, such as the channel selection modules 450 and 460 depicted in FIGS. 4D and 4E, respectively. While the threshold adjuster 452 is described for purposes of illustrating the method 800, it is understood that other devices, such as the offset adjuster 464, may be used.

The sound processor 208 performs the method 800 after Y samples, where Y is a positive integer. A value of Y depends on a desired update rate of the threshold energy. For instance, the value of Y is one in the examples described with respect to FIGS. 4D, 4E, 5C, 5D, 5E, and 5F.

In another example, the sound processor 208 averages the number of spectral components included in the channel-magnitude signals over a period of time Y is defined as a time value rather than a number of samples. In this example, a value of Y may be a relatively long period of time, such as, for example, one second or even several seconds. This allows the processors to average a sufficiently large sample of stimulation signals. As another alternative, the value of Y is based on the sampling rate used by the sound processor 208 when processing sound. For instance, the value of Y is ten times the sampling rate. In another example, the value of Y is more or less than ten times the sampling rate. Additionally, the recipient may adjust the value of Y (or perhaps a value of a multiplier used to determine the value of Y), depending on the situation.

In one example, the target number is predetermined, either at the point of manufacture or during the fitting process. Alternatively, the recipient adjusts the target number during use, depending on the recipient's preference in a given acoustic environment. For instance, if the recipient desires improved temporal resolution, the recipient lowers the target number. In contrast, if the recipient desires improved spectral resolution, the recipient increases the target number.

As another example, the sound processor 208 is configured to reduce the target number based on an amount of charge of the power supply 202. When the sound processor 208 determines that the charge of the power supply 202 is below a threshold charge, the sound processor 208 decreases the target number. Additionally, the sound processor 208 may incrementally decrease or increase the target number as the charge of the power supply 202 decreases or increases, respectively.

At block 802, the method 800 includes determining an average of a number of spectral components used to generate the last Y stimulation signals. For each stimulation signal, the sound processor 208 determines the number of stimulation spectral components included in the stimulation signal.

The sound processor 208 stores information indicative of the number of spectral components, such as an individual number of stimulation spectral components or a running sum of the number of stimulation spectral components, in the data storage 206. After determining that the Yth stimulation signal has been generated, the sound processor 208 calculates an average number of stimulation spectral components included in the last Y stimulation signals.

At block 804, the method 800 includes rounding the average number of spectral components to a nearest whole number. The sound processor 208 rounds the average number of spectral components using standard rounding rules (i.e., averages between 6.5 and 7.4 are rounded to 7). Alternatively, the sound processor 208 may use a different set of rounding rules when rounding the average number of spectral components.

At block 806, the method 800 includes a decision point. If the rounded average is less than the target number, the method 800 proceeds to block 808. If the rounded average is greater than the target number, the method 800 proceeds to block 810. If the rounded average equals the target number, the method 800 ends.

At block 808, the method 800 includes decreasing the threshold energy level. The sound processor 208 can decrease the threshold energy in a number of ways. As one example, the sound processor 208 decreases the threshold energy by applying a reduction factor to the threshold energy, perhaps by multiplying the threshold energy by the reduction factor.

In one example, the reduction factor is a fixed number, such as one decibel. In this example, the threshold energy is reduced by one decibel each time the reduction factor is applied.

In another example, the reduction factor varies depending on the frequency of adjustments made. That is, the sound processor 208 increases the value of the reduction factor if the sound processor 208 performed the steps of block 808 in the previous iteration of the method 800 or, alternatively, within a certain period of time. For instance, if the sound processor 208 reduced the threshold energy by one decibel during the previous iteration of the method 800, the reduction factor will decrease the threshold energy by two decibels during the current iteration of the method 800. In this example, the difference between the initial threshold energy and the final threshold energy is three decibels.

Further, if the sound processor 208 determines that the rounded average is less than the target number during the previous two iterations of the method 800, the reduction factor will reduce the threshold energy by four decibels, and the total reduction in the threshold energy will be seven decibels. Varying the reduction factor in this way may return the average to the target number more rapidly than using a fixed reduction factor. Note that, the difference between any two reduction factors may be more or less than those described in the preceding examples. Once the round average equals the target number, the sound processor 208 may reset the reduction factor to the initial reduction factor (e.g., one decibel in the preceding examples).

In yet another example, the reduction factor varies between frequency channels. That is, the reduction factor applied to a threshold energy of a first frequency channel may be greater than or less than the reduction factor applied to a threshold energy of a second frequency channel.

At block 810, the method 800 includes increasing the threshold energy level by an adjustment factor. The sound processor 208 increases the threshold energy by applying an adjustment factor to the threshold energy level, perhaps by multiplying the threshold energy by the adjustment factor.

As with the reduction factor, the adjustment factor is either a fixed value or varies based on the number of successive iterations (or the number of iterations within a time period) of the method 800 in which the sound processor 208 performs the steps of block 810. The adjustment factor may also vary between frequency channels. That is, the adjustment factor applied to a threshold energy of a first frequency channel may be greater than or less than the adjustment factor applied to a threshold energy of a second frequency channel. In one example, the adjustment factor is about the same as the reduction factor. In another example, the adjustment factor is more or less than the reduction factor.

After performing the steps of one of blocks 808 or 810, the method 800 ends.

With respect to any or all of the message flow diagrams, scenarios, and flow charts in the figures and as discussed herein, each step, block and/or communication may represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages may be executed out of order from that shown or discussed, including in substantially concurrent or in reverse order, depending on the functionality involved. Further, more or fewer steps, blocks and/or functions may be used with any of the message flow diagrams, scenarios, and flow charts discussed herein, and these message flow diagrams, scenarios, and flow charts may be combined with one another, in part or in whole.

A step or block that represents a processing of information may correspond to circuitry that can be configured to perform the specific logical functions of a herein-described method or technique. Alternatively or additionally, a step or block that represents a processing of information may correspond to a module, a segment, or a portion of program code (including related data). The program code may include one or more instructions executable by a processor for implementing specific logical functions or actions in the method or technique. The program code and/or related data may be stored on any type of computer-readable medium, such as a storage device, including a disk drive, a hard drive, or other storage media.

The computer-readable medium may also include non-transitory computer-readable media such as computer-readable media that stores data for short periods of time like register memory, processor cache, and/or random access memory (RAM). The computer-readable media may also include non-transitory computer-readable media that stores program code and/or data for longer periods of time, such as secondary or persistent long term storage, like read only memory (ROM), optical or magnetic disks, and/or compact-disc read only memory (CD-ROM), for example. The computer-readable media may also be any other volatile or non-volatile storage systems. A computer-readable medium may be considered a computer-readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A sound processor configured to:
generate a stimulation signal based on one or more spectral components having an energy that is greater than or equal to one or more threshold energies, wherein each of the one or more spectral components represents an energy of a sample of an audio signal at one of M frequency channels, and wherein M is a positive integer.

2. The sound processor of claim 1, wherein the sound processor is further configured to:
receive a spectral signal having M spectral components, wherein each spectral component corresponds to one of the M frequency channels;
receive information indicative of M threshold energies, wherein each of the M threshold energies corresponds to one of the M frequency channels, and wherein the one or more threshold energies are included in the M threshold energies; and
determine, for each of the M frequency channels, whether the energy of the spectral component is greater than or equal to the threshold energy corresponding to that frequency channel.

3. The sound processor of claim 2, wherein each of the M threshold energies has a same value.

4. The sound processor of claim 1, wherein each of the one or more threshold energies is determined such that, for a plurality of stimulation signals, an average of a number of spectral components used to generate each stimulation signal is within a tolerance of a target number.

5. The sound processor of claim 1, wherein the one or more threshold energies include a threshold energy for each of the M frequency channels, and wherein at least two of the M frequency channels have different threshold energies.

6. The sound processor of claim 1, wherein at least one of the one or more threshold energies is a threshold energy for two or more of the M frequency channels.

7. The sound processor of claim 1, wherein the sound processor is further configured to:
provide one or more noise floors by estimating a noise floor for one or more of the M frequency channels; and
determine the one or more threshold energies based on at least the one or more noise floors.

8. The sound processor of claim 7, wherein the one or more noise floors include M noise floors, wherein each of the M noise floors corresponds to one of the M frequency channels, and wherein, to determine the one or more threshold energies, the sound processor is further configured to determine, for each of the M frequency channels, that a threshold energy for the frequency channel is the noise floor of the frequency channel.

9. The sound processor of claim 7, wherein the sound processor is further configured to determine the one or more threshold energies by applying an offset to each of the one or more noise floors.

10. The sound processor of claim 9, wherein a value of the offset varies for one or more of the M frequency channels.

11. A non-transitory computer-readable memory having stored therein instructions executable by a computing device to cause the computing device to perform functions comprising:
generating a spectral signal that includes M spectral components of an audio signal, wherein each spectral component includes information indicative of an energy of the audio signal in one of M frequency channels, and wherein M is a positive integer;
for each of the M spectral components:
(i) determining whether the energy of the spectral component is less than a threshold energy of an associated frequency channel, wherein the associated frequency channel is included in the M frequency channels, and
(ii) in response to determining that the energy of the spectral component is less than the threshold energy, removing the spectral component from the spectral signal; and
generating a stimulation signal based on one or more of the M spectral components remaining in the spectral signal.

12. The non-transitory computer-readable memory of claim 11, wherein each of the M frequency channels has a same threshold energy.

13. The non-transitory computer-readable memory of claim 11, wherein at least two of the M frequency channels have different threshold energies.

14. The non-transitory computer-readable memory of claim 11, wherein the functions further comprise:
estimating a noise floor of each of the M frequency channels; and
determining, for each of the M frequency channels, the threshold energy based on at least the noise floor of the frequency channel.

15. The non-transitory computer-readable memory of claim 14, wherein, for each of the M frequency channels, the threshold energy is the noise floor of that frequency channel plus an offset.

16. A method comprising:
determining an average of a number of spectral components used to generate one or more stimulation signals during an interval;
making a determination that the average and a target number are different numbers; and
in response to making the determination, adjusting a threshold energy used to select one or more subsequent spectral components, wherein the one or more subsequent spectral components are used to generate one or more subsequent stimulation signals.

17. The method of claim 16, wherein adjusting the one or more threshold energies comprises:
determining whether the average is greater than the target number or less than the target number;
in response to determining that the average is greater than the target number, increasing the one or more threshold energies; and
in response to determining that the average is less than the target number, decreasing the one or more threshold energies.

18. The method of claim 17, further comprising:
determining whether a first adjustment was applied to the one or more threshold energies during a previous interval; and
in response to determining that the first adjustment was applied, applying a second adjustment to the one or more threshold energies, wherein the first adjustment and the second adjustment have different values.

19. The method of claim 16, wherein the average is a number of spectral components included in a single stimulation signal.

20. The method of claim 16, wherein the one or more stimulation signals include multiple stimulation signals, and wherein making the determination includes rounding the average to a nearest whole number.
